(19) United States
(12) Patent Application Publication
(10) Pub. No.: US 2021/0012556 A1
(43) Pub. Date: Jan. 14, 2021

(54) SYSTEM AND METHOD FOR 3D-MODELLING AN ENVIRONMENT AND INTEGRATING REAL-TIME OBSERVATIONAL TOOLS

(71) Applicant: DIMENSIONAL ASSET SOLUTIONS, LLC, Weatherford, TX (US)

(72) Inventors: ROSS H. WATKINS, WEATHERFORD, TX (US); SIERRA BREANN POTTS, WEATHERFORD, TX (US); STEVE TANNER CLARK, CANYON, TX (US); ADDISON WAYNE RHUDY, MISSOURI CITY, TX (US)

(21) Appl. No.: 16/906,605

(22) Filed: Jun. 19, 2020

Related U.S. Application Data
(60) Provisional application No. 62/864,901, filed on Jun. 21, 2019.

(51) Int. Cl. G06T 15/20; G06T 15/08

(52) U.S. Cl. CPC G06T 15/205; G06T 2211/428; G06T 2210/04; G06T 15/08

(57) ABSTRACT

System and method for interfacing real-time observational tools with digital, 3D-modelled representations of real-world locations. Embodiments of the present invention are directed to allowing access to various on-site camera, or other data-collecting, systems via user interaction with digital location models made available on an online platform.

### CITATION TO PRIOR APPLICATIONS

The present application is a continuation of and claims priority to U.S. Provisional Application No. 62/864,901, titled “SYSTEM AND METHOD FOR 3D-MODELLING AN ENVIRONMENT AND INTEGRATING REAL-TIME OBSERVATIONAL TOOLS” and filed Jun. 21, 2019.

### BACKGROUND AND SUMMARY OF THE INVENTION

The present invention relates generally to the integration of real-time observational tools into digital, 3D-modelled locations that utilize specialized, mapped location data and a related software platform that interfaces with such data.

While prior art approaches for creating digital location models allow for interaction with such models to an extent including simulated walkthroughs of interior spaces, the present invention integrates additional information into mapped location data to provide further practical utility. It is one object of the present invention to allow couple real-time observational tools to the mapped location models. Users may then access the mapped location models and any related information via a web-based, or other software, platform.

Through this coupling of data, a dynamic system is created through which users may remotely monitor on a computing device conditions of any real world site that has been mapped and modelled as contemplated by the present invention. Specifically, and improving over the capabilities of the prior art, the integration of real-time observational tools allows for the remote monitoring and guidance of emergency, rescue, or other personnel as they traverse interior physical spaces captured by mapped location models.

### BRIEF DESCRIPTION OF THE DRAWINGS

FIG. 1 depicts one implementation of a UI element representing a layered property map having camera feed buttons.

FIG. 2 depicts one implementation of an iFrame including 3D-modelled imagery of an interior location.

FIG. 3 depicts one implementation of a UI element representing a Panel Bar, Insert Form, and Grid as used throughout the platform of one embodiment of the present invention.

FIG. 4 depicts one implementation of a UI element representing a Location page from one embodiment of the present invention with the “Add Location” panel toggled open.

FIG. 5 depicts one implementation of a UI element representing an LIM page from one embodiment of the present invention with the “Add LIM” panel toggled open.

FIG. 6 depicts one implementation of a UI element representing a Maps Setting page from one embodiment of the present invention.

FIG. 7 depicts one implementation of a UI element representing a document control file explorer from one embodiment of the present invention.

FIG. 8 depicts one implementation of a UI element representing a Register User form from one embodiment of the present invention.

FIG. 9 depicts one implementation of a UI element representing a User Lists page from one embodiment of the present invention.

FIG. 10 depicts one implementation of a UI element representing a Change Password form from one embodiment of the present invention.

FIG. 11 depicts one implementation of a UI element representing a Locations Users grid from one embodiment of the present invention.

FIG. 12 depicts one implementation of a UI element representing a Locations Lists grid from one embodiment of the present invention.

FIG. 13 is a site map according to one embodiment of the mapped location interface platform of the present invention.

### DETAILED DESCRIPTION

This description, along with the accompanying figures, presents non-limiting examples of embodiments of the present invention. Although specific structures or methodologies are described herein (for example, accessing a camera's video feed through a manufacturer API request utilizing the camera's serial number) as system components or to accomplish various processes, these are not intended to be limiting, and one of ordinary skill in the art would recognize that other structures or methodologies could be similarly employed. Similarly, any specific reference to any pages, elements, or events are merely exemplary of certain embodiments of the present invention.

Certain embodiments of the present invention comprise a set of mapped location data. This set of mapped location data may itself include at least one digital location model or image, data representing a static geographic position, and secondary model information representing additional details about positions within or items or objects related to a location. These embodiments may further comprise data from real-time observational tools (such as cameras). Some embodiments will also comprise a mapped location interface platform configured to allow users to interact with, and in some cases modify, said set of mapped location data.

In other embodiments, the set of mapped location data may comprise a plurality of digital location models or images that, as combined, create a digitally traversable 3D-space representing an area within a location.

One non-limiting embodiment of the present invention, describing properties of said set of mapped location data, and the manner in which real-time observation tools are coupled with said set of mapped location data, is set forth below from the perspective of implementing the mapped location interface platform. The platform, or system, comprises numerous pages that themselves implement or enhance platform functionality.

Application Framework. The application may be built using ASP.NET MVC framework. This is a framework that specializes in building web apps using the Model-View-Controller design pattern. The application may be created with three projects that follow the MVC pattern and a fourth project that will be a Windows Service that is responsible for collecting the GPS data from the GPS devices.

Additional Frameworks. There are also several different UI helpers and script libraries that need to be installed. Some of the other frameworks that need to be included in the application are:
Kendo UI Suite to enhance the ASP.NET/HTML Input controls.
jQuery to enhance JavaScript functionality.
NewtonSoft.Json to help format the data that is being transmitted between the APIs, client, and serve.
Angular to help add data management to standard HTML tags and JavaScript.

Web Application (View and Controllers) Project. During the creation of the Web Application project, the integrated development environment (“IDE”) may set up several default folders and files. Folders for Views, Controllers, Scripts, Styles, and a Web.Config file may be created. Then, in the newly created folders, default files for controllers, views, scripts, and styles may be added. Before continuing, the database location and name should be configured. Additionally, the database authentication information should be specified. These settings may be added to the web.config file and may be used by ASP.NET Identity and the Database Project.

The web application will need to be integrated with the ASP.NET Identity system. This system provides the backbone to the authentication services. When setting up ASP.NET Identity select the option to use “Individual Accounts.” Doing so will mean that each user will have their own username and password. Then create a password policy and set up two separate roles. The first role may be “Administrator.” Users with this role will have permissions to all pages and features. The other role created may be “Location User.” Users with this role will only have access to selected locations assigned to them and the 3D Imagery associated with those locations. The ASP.NET Identity installation includes several new views, controllers, and, based on the initial configuration, provides the membership entities class. The Identity installation will create the application's database with the necessary tables that Identity needs to manage user accounts and roles. The new database that ASP.NET Identity creates will also be the primary database for the rest of the solution.

The MVC web application utilizes shared views that will act as a master page. These shared views will store the Style Sheet Locations, Script File Locations, a header, menu, and footer. When content views are created, a default shared view should be specified so that all pages can have the same header, menu, footer, etc. without having to re-code those on every page.

Views and controllers should then be created to manage Customers, Locations, 3D Image Window per location, 3D Image Mini-Map Settings, 3D Image Mini-Map GPS configurations, GPS Devices, Personnel Management, and User Configurations. User Configurations include views that will allow an Administrator to set up new users, assign Location Users access to their specific Locations, reset passwords, and assign GPS devices to Personnel Users.

Each view should include:
Customers (Insert form, Grid to reading data, Edit, and delete)
Locations (Insert form, Grid to reading data, Edit, and delete)
3D Image Windows per Location (Insert form, Grid to reading data, Edit, and delete)
3D Image Mini-Map Settings
3D Image Mini-Map GPS Configuration
Centralized Documents Control (Web-Based File Explorer)
Building Management
Restricted Areas—Create and Assign users to Restricted Areas
GPS Devices (Insert form, Grid to reading data, Edit, and delete)
GPS Device—Assign Users
Bluetooth Low Energy (BLE) Devices
Bluetooth Low Energy (BLE) Devices—Assign Users
Camera Feed Management
Personnel Management (Insert form, Grid to reading data, Edit, and delete)
User Management for each role (Insert form, Grid to reading data, Edit, and delete)
Assign Location Users (see Assign Device to Personnel User section)
Organization Registration
External Users—Assign GPS and BLE Devices
Reset Password Form
Add GPS Devices to Personnel Users (Insert form, Grid to reading data, Edit, and delete)

Location User Views/Controllers should then be created. This will include two views:
Location 3D Image Window—Will include the integrated iFrame for the 3D Imagery provided by the camera manufacturer. Mini-Map will be in top-right corner of the 3D Image Window.
Floor Plan Mode—This will be a top-down view of the facility floor plan. It will display GPS and BLE markers for each Personnel User.

Model Project. In this project, Models and ViewModel objects may be declared. Each Model may be a cs file containing the various properties that will be used by that object. A reference should be set up in the Web Application Project to the Model Project so that they can share components. Each Model object will also represent a database table that will be created in the Database Project. After creating a schema mock-up, actual cs files may be created. The Data Annotations assembly may be used to specify required properties, foreign keys, and display names. The classes that need to be created are “Customers,” “Personnel User” (with a foreign key to “Customers”), GPS Device (with a foreign key to customers), “Personnel User GPS Device” (with foreign keys to “Personnel Users” and “GPS Devices”) , “Locations” (with a foreign key to “Customers”), “Location 3D Imagery” (with a foreign key to “Locations”), and then a table to store which “Locations” a “Location User” has been assigned. This embodiments may include the following classes: “Document Library,” “Document Library Resource,” “Restricted Area,” “Restricted Area User,” “Restricted Area Organization,” “Building,” “Camera Feed CCTV,” “Camera Feed Mobile,” “Body Cam,” and “License Plate Scanner”; all of which will have a foreign key “Location.” Once the Model Project is built, the Database Project may be created and the tables added to the database that ASP.NET Identity created during the Web Project setup.

Database Project. The first step in setting up the Database Project is to install the latest version of Entity Framework by using the IDE's package manager. Entity Framework is used to manage the communications between the application and database. It serves as a map between the users submitting forms and how the data ends up in the database. Next, a DbContext is created and all the Model objects are specified in the Model Project as Db Set objects. Then, Code First Migrations may be enabled and the Update-Database script may be run in the package manager. This will add all the tables to the database and create a migration file that will track the schema changes.

Database Server. A database engine, running on “server level” hardware, may be used to store the data and documents. The tables in the database will mirror the model objects specified in the Web Application Project (for Identity) and the Model Project.

Property Map with Layers Page. When a user with the role of “Location User” logs into the system they are directed to their “Property Map with Layers.”

The property map may be captured via a flown manned aircraft or drone. A specialized camera system on the craft is configured to take very large images at high resolutions. That image is processed through specialized software that will tie GPS points together and create tiles from the image. Those tiles (MB Tiles) are then uploaded to a mapping service provider and configured to be embedded into the application. The generated map is laid over a real-world map that matches up the longitude and latitude to create a seamless integration showing the custom image map. This allows for manipulation (such as pan, zoom, and pitch adjustment) of the custom image map.

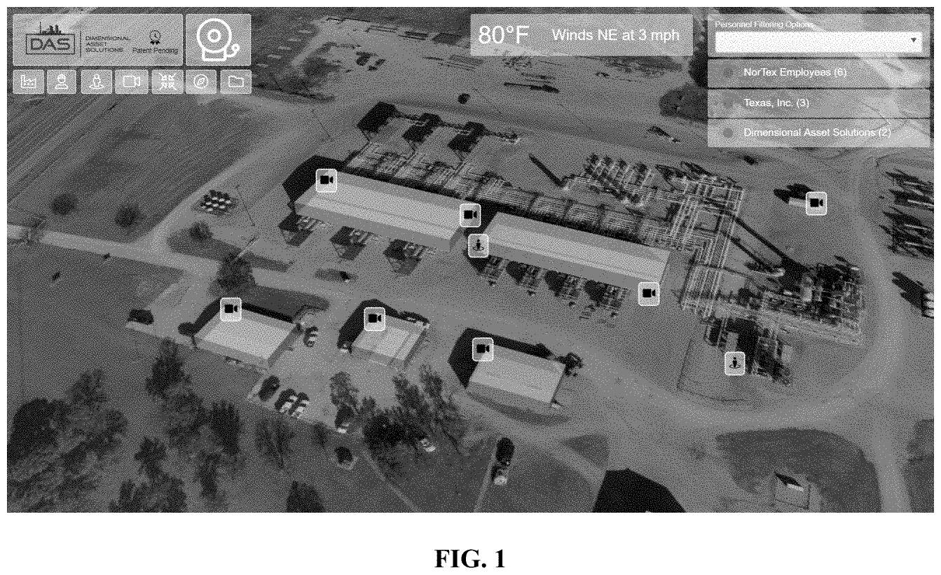

As depicted in FIG. 1, layers may be added to the map and can be toggled on and off by the user. These layers contain specific subsets of data and custom styling rules can be applied. The following layers are may be included in the application:
Building Outlines—The buildings are highlighted on the property. These building outlines can be toggled on or off.
Personnel and Contractor Tracking (GPS)—Employees/Contactors can be equipped with a GPS tracking device that will communicate back to the map. These GPS tracking points can be toggled on and off. There may also be a dropdown to search for individuals.
Customizable Contractor Filter Buttons—Each contractor that has employees on site may be listed as an individual layer. These layers are toggled on and off to highlight specific contractors if needed.
Ground-Level 3D Imaging Points—These buttons can be toggled on and off. Clicking one of these buttons will take the user into a ground-level 3D view of that building or area. The user can then walk-through the preset locations points.
Camera Feed Buttons—Camera buttons can be toggled on and off. Clicking the camera will allow the user to view that feed.
Safety Areas—Safety Areas (or Muster Areas) are toggled on and off

This page may have the following features incorporated into it:

Current Conditions—The application may be integrated with current weather conditions that are provided by a nation weather service API.

Emergency Mode—If personnel with GPS devices are being tracked, enabling this mode (such as through clicking a button) will turn personnel icons red until they have entered the pre-defined safety areas. This will also send out text alerts to user specified contacts. Emergency Mode can be turned on and off.

Restrictive Areas—When a GPS Device enters an area that has been configured as a restrictive area it will take that deviceID and see if it is approved to be in that location. If not, it will send a text alert to the configured contact that corresponds to the deviceID.

Centralized Document Control List—Toggles a documents list on and off.

Reset Pitch, Pan, and Zoom. Clicking this button will reset the view back to a default view that is centered around the property.

This Razor page (view) may be built inside of a shared view so that it can use the application's master header, menu, and footer. This page also has a corresponding method inside its controller. The method in the controller checks to see if the user is authenticated and has permissions. The method in the controller uses C#. The view uses HTML, C#, CSS, JavaScript, jQuery, and Angular to import the map, populate data and styles for the layers, get the list of documents, populate the personnel dropdown, and get current weather conditions. When the page loads, it will make a call to the weather service to get current conditions and populate the labels with the data retrieved. Next, the page requests the map information from the mapping service provider. Data is then used to populate the different control with specific values that are used to display the correct map. Doing that also sets the default coordinates, pitch, and zoom that can be reset at any point by the user. Once the map is loaded, it makes a call to the database to get the latest GPS coordinates of individual personnel and contractor employees. While loading the contractors it will but add a button to the right side of the screen that allows the user to toggle the contractor employees on and off. It also makes a call to the database to populate a dropdown list with all the tracked persons and is configured to be searchable. Once the GPS locations are populated, it gets the coordinates and style settings for the buildings, cameras, safety areas, and other features the customer wishes to highlight. These settings are saved in the database and once requested the system returns Json and adds those settings to the map. Once the GPS units, weather, layers, and contractor dropdown are populated, the system adds the buttons that toggles the layers on and off. Now the system loads the documents (with a default setting of “Hide”) and prepares the buttons that takes the user into the ground-level 3D imagery of inside the buildings.

This embodiment may include numerous features such as those described in greater detail below.

Map—Technical Details. Base Element:
div

Events. Using the mapping service provider's API and jQuery, an access token object may be created with the token provided by the mapping service.

Based on the customer user login and location ID that is provided to the view by the controller, the specific map settings are requested from the database.

The datasource of the map may be set using the setting and fields from the database. Using the API documentation, this datasource can be set to populate a specific element (div). This is also were the default pan, zoom, and pitch values are set.

Building Outlines—Technical Details. Base Elements:
Map div—Added to the data source of the map via jQuery
div—Button to toggle layer on and off

Events. Request Data for map—Based on CustomerID and LocationID of the logged in user, the system will post a request to the database and receive Json with the appropriate boundaries, colors, and coordinates for any buildings. It will then add those settings to the map and display on the page. These settings are identified by an ID that can be used on the click event to show and hide. These properties are added in the “Building Management” module.

If Bluetooth Low Energy (BLE) is enabled for the building, the system will add an icon to open a high-resolution blueprint or image of the building layout that will show dots for each tag reporting to the BLE beacons. The beacons and tags will communicate with the BLE hardware manufacturer and then the location information will be requested from them. The tags will show user information when clicked. The tags are configured and assigned on the BLE tags management page.

Click Event (Button)—When clicked it will call the layer by ID and toggle its display.

Personnel and Contractor Tracking (GPS)—Technical Detail. Base Elements:
Map div—Added to the data source of the map via jQuery
Dropdown for GPS device search (Devices are associated with personnel and contractor employees)

Events. Request Data for map—Based on CustomerID and LocationID of the logged in user, the system will post a request to the database and receive Json with the appropriate coordinates. If the coordinates fall within the Feature Geometry Coordinates of the property, the system will add it to the list. The system will then add those settings to the map and display them on the page. The color and icon type are also specified at this time based on mapping service provider API documentation. Personnel and contractor groups are identified by an ID that can be toggled by a button click event to show and hide.

GPS/BLE Device Icon Click—When a dot of a GPS or BLE device is clicked on, it will pop open a new window that will display that user's (or guest) information card and list relevant certifications. Clicking the close icon or somewhere else on the screen will close the popup.

Request Data for Dropdown—Based on CustomerID and LocationID of the logged in user, the system will post a request to the database and receive Json with the ID and coordinates of the GPS devices being tracked.

Change Event (Dropdown)—When changed, the system will take the ID of the selection item and make a call to the database to request the specific object. The server will return the object's coordinates and call a method to get the Map object and fly to the coordinates of the object selected. This call will be made with the specification of the mapping service provider documentation.

Customizable Contactor Filter Buttons—Technical Details. Base Element:
div—Buttons to toggle contractor layers on and off. Buttons are added via jQuery as the GPS Tracking devices for each contractor is loaded.

Events. Click Event (Buttons)—When clicked it will call the layer by ID and toggle its display. While loading the contractor GPS coordinates to the map data source, the system will add the buttons to the right side of the screen that can toggle the individual contractor groups on and off.

Ground-Level 3D Image Points—Technical Details. Base Elements:
div—Button to toggle layer on and off
div—Button to open 3D Image Walk-Through of the location
iFrame—Primary container for the 3D Image Walk-Through
div—Button to close the 3D Image Walk-Through
div—“Field of View” blueprint mini-map

Events. Click Event (Layer Button)—When clicked, it will call the layer by ID and toggle its display to hide or show the 3D Image Walk-Through Buttons.

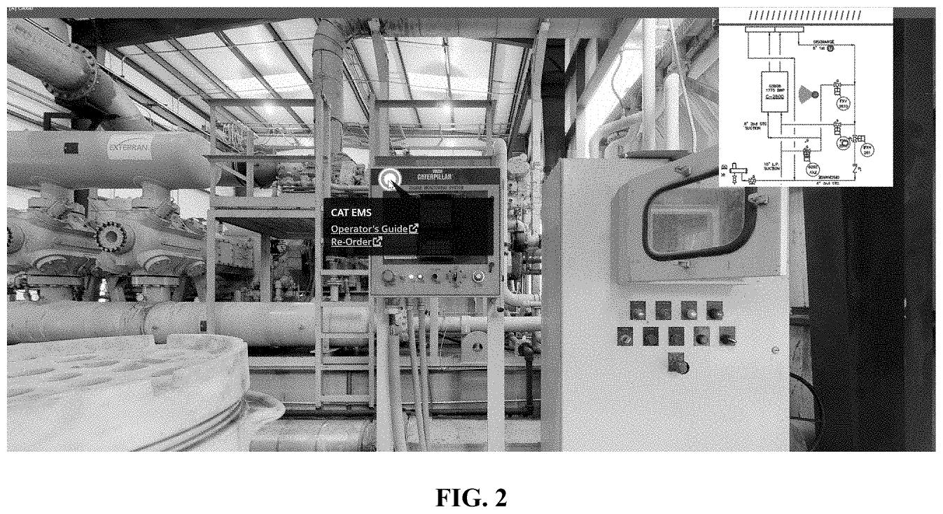

Click Event (3D Image Walk-Through Button)—When clicked, it will call the layer by ID and, based on the mapping service provider's API, will fly into the area of the button that was clicked. While zooming into the area, the system will make a database call to retrieve the 3D Image object and, using jQuery, will use that data to populate the source of the iFrame and background image of the mini-map. The system will then bring the container of the iFrame to the front and add a close button to the top left. The iFrame will load the imagery from the camera manufacture's API that allows the user to walk through their location as shown in FIG. 2.

Loading Camera Location Spots—When loading the camera location spots on the mini-map, a connection is created to the camera manufacturer's API and requests are made, using a security token, for corresponding objects. The locations of all the Camera Location Spots are returned along with the view dimensions of the current user's location. The Camera Location Spot element may be layered above the blueprint/mini-map layer.

Changing Field of View Cone—The Field of View cone for the current user that is in the blueprint/mini-map may also be configured to change. Using the existing 3D Image object, the field of view that is displaying on the screen can be determined. The field of view may be stored as numbers/dimensions. Those dimensions can be used, in a calculation, to determine a field of view cone on the blueprint/mini-map. The cone is a div with CSS properties. Whenever the field of vision is moved, the system calls an event that updates the calculation and changes the CSS to match.

Camera Feed Buttons—Technical Details. Base Elements:
div—Button to toggle layer on and off
div—Individual Camera Feed Buttons
iFrame—Camera Feed

Events. Click Event (Layer Button)—When clicked, the system will call the Camera layer by ID and toggle its display.

Request Data for map—Based on CustomerID and LocationID of the logged in user, the system will post a request to the database and receive Json with the appropriate coordinates of the camera feed locations. It will then add those settings to the map and display on the page.

Click Event—Stationary CCTV Camera Feed & License Plate Scanner: Each camera may have a clickable GPS Coordinate Dot on the property map. When the dot is clicked, the system will open an information card with a link to open the feed. The feed will be displayed/sent to the client via, or as a result of, the manufacturer API.

Click Event—Mobile Camera Feed & Body Cam Feed: These camera systems will have a GPS Coordinate posted to system's server and will have a corresponding GPS Coordinate Dot placed on the property map. When the dot is clicked, the system will open an information card with a link to open the feed. The feed will be displayed/sent to the client via, or as a result of, the manufacturer API.

Safety Areas—Technical Details. Base Elements:
div—Added to the data source of the map via jQuery
div—Button to toggle layer on and off

Events. Request Data for map—Based on CustomerID and LocationID of the logged in user, the system will post a request to the database and receive Json with the appropriate boundaries, colors, and coordinates. It will then add those settings to the map and display on the page. These settings are identified by an ID that can be used on the click event to show and hide.

Click Event (Button)—When clicked, it will call the layer by ID and toggle its display.

Current Weather Conditions—Technical Details. Base Element:
div with styles and labels

Events. Request Data—Based on CustomerID and LocationID of the logged in user, the system will post a request to the database to receive Json with the appropriate zip code and coordinates of the facility. It will then make a request to the weather service API with the location information to receive the current weather conditions for that area. The labels with the current weather conditions, such as temperature and wind speeds, will then be populated.

Emergency Mode—Technical Details. Base Element:
div with styles and icon
textbox to accept pin number for activation
button—to submit pin number

Events. Click Event (emergency mode button)—When clicked, the system will show a personal identification number (“PIN”) textbox and submit button. This may be used is to verify that the user has permission to activate/deactivate Emergency Mode.

Click Event (submit PIN)—When clicked, the system will send the PIN that the user typed into the textbox to the database for verification. If authentication is successful, the emergency mode element will start to blink pink then red. In certain embodiments, a setInterval may be used to alternate the colors every second. Next, the system reloads the GPS Location dots with the color setting of red. Every time a GPS location dot checks in, the server will determine if it is inside the coordinates of a safety area. If it is not in a safety area, the system will keep its color red. If it is in a safety area, the system will return to the default color for that dot. Clicking the “Emergency Mode” button after it has been activated will prompt the user to re-type their PIN for verification. Then it will cancel the setInterval, return the color of the div back to its normal color, and re-load all the GPS location devices with their default color.

Text Alerts—If the emergency mode is activated, the system will make a call to the database and return a list of contacts that have been configured to receive alerts. Using jQuery, it will loop through the list of contacts making a call to the SMS provider (with code specified by their API documentation) to send the message.

Restrictive Areas—Technical Details. Base Element:
div with styles and alert icon

Events. Device Enters Restricted Area—When a GPS Device enters an area that has been configured as a restrictive area, the system will take that deviceID, make a call to the database, and see if it is approved to be in that area. If the deviceID is not, the system will turn that restrictive area red by adding the coordinates to the map's datasource. It will also toggle the alert icon on or off and, with a setInterval method, will start alternating pink and red (via CSS and jQuery). Upon the device leaving that area, the system will turn the area back to a normal color and remove the alert icon. A text message is also sent when the restrictive area alert is triggered and cleared.

Text Alerts—If a restricted area alert is activated, the system will make a call to the database and return a list of contacts that have been configured to receive alerts. Using jQuery it will loop through the list of contacts making a call to the SMS provider (with code specified by their API documentation) to send the message.

Centralized Document Control List—Technical Details. Base Elements:
div—button to toggle documents list
Wrapper that list the documents. Contains links to the documents, a link to open the document library in a web-based file explorer, and a button to add new documents. The web-based file explorer link opens in a new browser tab.

Events. Click Event (toggle button)—When clicked, the system will toggle the display of the documents list.

Wrapper—On page load, the system will grab the list of documents from the database based on the CustomerID and LocationID of the logged in user. It will sort them alphabetically and allow the user to click the link to open the document in a new window. The documents list has three columns: Column 1 is the icon of the document type (i.e. PDF, Word, Excel); Column 2 is the name of the document; and Column 3 is the date uploaded. In the top right of the wrapper is the “Add Document” icon.

Click Event (add document icon)—When clicked, the system will pop open a box that will allow the user to browse to a location on their local file system. They can select a one or many files and click the “Upload” button. It will then add the document to the database and rebind the document list to include the new document.

Reset Pitch, Pan, and Zoom—Technical Details. Base Element:
div with styles and icon

Events. Click Event—When clicked, the map object may be specified and an event called, based on mapping service provider API, to fly to the specific default view and coordinates.

This embodiment may also include the pages as specified and described more thoroughly below.

Customer Management Page. The customer management page is where the primary account for each customer may be tracked. This page includes a “Panel Bar” that will open and collapse upon clicking. When opened, it will display the customer insert form. When collapsed, it will hide the customer insert form and has the title of “Add Customer.” Under the “Panel Bar” is a grid listing all the customers in a table. It is pageable table with sortable column headers and data rows. Each row is a customer. In addition to the customer data in each row there are also three buttons:
Edit button: When clicked, it will disable the primary features of the customer page with a shaded overlay and then opens a pop-up that lists all the customer properties in an editable form.
Delete Button: When clicked, it will prompt a user to verify that they want to delete the customer. If the user clicks “OK,” it will mark the customer as deleted in the database. Nothing is deleted, just hidden. If the user clicks “Cancel,” it will return the user to the normal screen.
Locations Button: When clicked, it will take the user to that customer's location screen.

Form Properties:
Name—Textbox, Alpha-Numeric, Required, Filterable by Text, Sortable
Account Number—This will be manually assigned to fit the current customer identification scheme. Textbox, Alpha-Numeric, Required, Filterable by Text, Sortable
Address 1—Textbox, Alpha-Numeric, Required, Sortable
Address 2—Textbox, Alpha-Numeric, Optional, Sortable
City—Textbox, Alpha-Numeric, Required, Sortable
State—Dropdown containing all 50 States and Washington DC, Alpha-Numeric, Required,

Sortable
Zip Code—Textbox, Alpha-Numeric, Required, Sortable
Phone Number—Masked Textbox, Numeric, Required, Sortable
Primary Contact Name—This is the full name of the primary contact with the customer. Textbox, Alpha-Numeric, Optional, Sortable
Primary Content Email Address—Textbox, Alpha-Numeric, Optional, Sortable
Primary Contact Phone Number—Textbox, Alpha-Numeric, Optional, Sortable
Logo—This will be uploaded to the server and used in reports. File Upload UI Component, Optional
Latitude—Numeric Textbox, Numbers, Optional
Longitude—Numeric Textbox, Numbers, Optional
Notes—It will store the customer notes in HTML format WYSIWYG Editor. Optional
Active—Boolean, Required, Filterable, Sortable

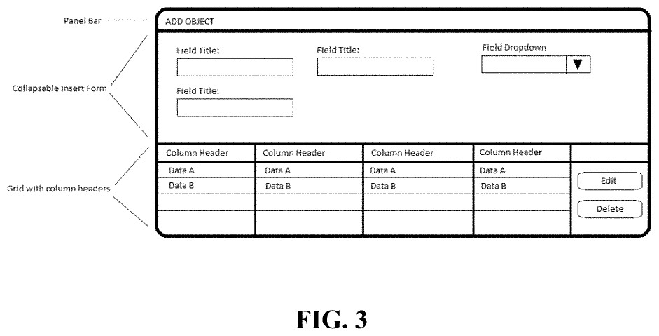

Customer Management Page Panel Bar, Insert Form, and Grid. This Razor page (view) may be built inside of a shared view so that it can use the application's master header, menu, and footer. This page also has a corresponding method inside its controller. The method in the controller checks to see if the user is authenticated, has permissions, and sets a ViewBag with the User's ID. The method in the controller uses C#. The view uses HTML, C#, CSS, JavaScript, jQuery, and Angular to build out the panel bar, insert form, and grid which may follow the form template set out in FIG. 3. This same template may be utilized for all forms described below that do not have a more particularized form structure set out. The panel bar is a Kendo Panel Bar built with an HtmlHelper block. It contains attributes for Name, Animation, and Items. The insert form is added to the “Items” section of the panel bar. The content inside the panel bar's “Item” section uses standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. When the grid is activated, a data source is set to a method inside the controller that returns the list of customers as a JSON object. Properties for the grid may also be defined. Examples of properties are width, pageable, scrollable, editable, etc.

Events. Insert Form Button Click—When clicked, the system creates variables for each input item and assigns it the value of the Angular scope property on that input item. Then each input value is added to a JSON string using the JSON.Stringify method. Once the string is set as JSON, the system posts that data to a method inside the CustomerController called “AddCustomer.” The AddCustomer method serializes the JSON string into a customer class object. Once it is an object, it is inserted into the database using Entity Framework. The results are passed back to the view and a message is displayed informing the user of the results.

Customer Edit Button Click—The “Edit” event will build out the form using a popup editor fired inside the script tag using a Kendo template. The system will load the data of the row from which the click fired into textboxes and other input items. Once the customer is edited, the system will post that data to the controller, and the controller will serialize the data into a customer object and update the row in the database using Entity Framework.

Customer Delete Button Click—When clicked, the system will fire the destroy method inside the grid. That will post the object to the destroy method in the controller and mark that customer as deleted. It will not actually remove any records from the database.

Locations Button Click—The “Location” button event will take a user to the location view corresponding to the customer Id.

Setting Data Source for Dropdown—The “State” dropdown in the address section of the insert form is set to an array of state names and abbreviations.

Location page. The Location page is where the Customer's Location(s) are tracked. Locations will have the 3D Location Image Maps. This page includes a “Panel Bar” that will open and collapse upon clicking. When opened, the system will display the Location Insert Form. When collapsed, the system will hide the Location Insert Form and has the title of “Add Location.” Under the “Panel Bar” is a grid listing all the Customer's Locations. It is a pageable table with sortable column headers and data rows. Each row is a Location. In addition to the location data in each row, there are also three buttons:
Edit button: When clicked, the system will disable the primary features of the location page with a shaded overlay and then opens a pop-up that lists all the location properties in an editable form.
Delete Button: When clicked, it will prompt a user to verify that the user wants to delete the location. If the user clicks “OK,” it will mark the location as deleted in the database. Nothing is deleted, just hidden. If the user clicks “Cancel,” it will return the user to the normal screen.
“Location Image Maps” Button: When clicked, it will take the user to that location's Image Maps.

Form Properties:
Name—Textbox, Alpha-Numeric, Required, Filterable by Text, Sortable
Account Number—This will be manually assigned to fit the current customer location identification scheme. Textbox, Alpha-Numeric, Required, Filterable by Text, Sortable
Address 1—Textbox, Alpha-Numeric, Required, Sortable
Address 2—Textbox, Alpha-Numeric, Optional, Sortable
City—Textbox, Alpha-Numeric, Required, Sortable
State—Dropdown containing all 50 States and Washington DC, Alpha-Numeric, Required, Sortable
Zip Code—Textbox, Alpha-Numeric, Required, Sortable
Location Logo—This will be uploaded to the server and used in reports. File Upload UI Component, Optional
Latitude—Numeric Textbox, Numbers, Optional
Longitude—Numeric Textbox, Numbers, Optional
Notes—It will store the location notes in HTML format WYSIWYG Editor. Optional

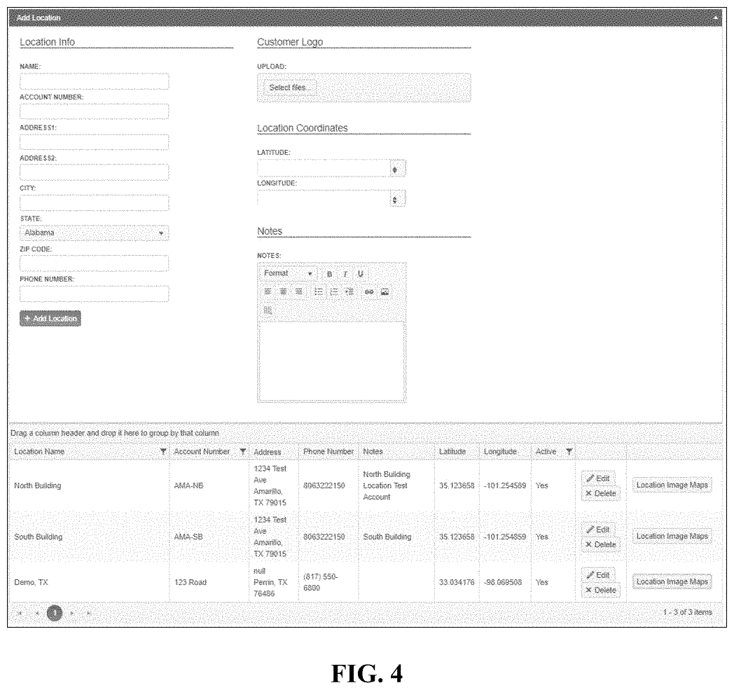

Location Page Panel Bar, Insert Form, and Grid. This Razor page (view) has been built inside of a shared view so that it can use the application's master header, menu, and footer. This page also has a corresponding method inside its controller. The method in the controller checks to see if the user is authenticated, has permissions, and sets two ViewBags with the User's Id and Customer's Id. The method in the controller uses C#. The view uses HTML, C#, CSS, JavaScript, jQuery, and Angular to build out the panel bar, insert form, and grid as shown in FIG. 4. The panel bar is a Kendo Panel Bar built with an HtmlHelper block. It contains attributes for Name, Animation, and Items. The insert form is added to the “Items” section of the panel bar. The content inside the panel bar's “Item: section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. When the grid is activated, a data source is set to a method inside the controller that returns the list of locations as a JSON object. Properties for the grid may also be defined. Examples of properties are width, pageable, scrollable, editable, etc.

Events. “Add Location” Button Click—When clicked, it creates variables for each input item and assigns it the value of the Angular scope property on that input item. Then each input value is added to a JSON string using the JSON. Stringify method. Once the string is set as JSON, it posts that data to a method inside the CustomerController called “AddLocation.” The AddLocation method serializes the JSON string into a location model object. Once it is an object, it is inserted into the database using the Data Project. The results are passed back to the view and a message is displayed informing the user of the results.

Location “Edit” Button Click—The “Edit” event will build out the form using a popup editor fired inside the script tag using a Kendo template. The system will load the data of the row from which the click fired into textboxes and other input items. Once the location is edited, it will post that data to the controller and the controller will serialize the data into a location model object and then update the row in the database using the Data Project.

Location “Delete” Button Click—When clicked it will fire the destroy method inside the grid. That will post the object to the destroy method in the controller and mark that location as deleted. It will not actually remove any records from the database.

“Location Image Maps” Button Click—The “Location Image Maps” button event will take the user to the LocationImageMap view with the location Id.

Setting data source for dropdown. The “State” dropdown in the address section of the insert form is set to an array of state names and abbreviations.

Location Image Map (LIM) Page. The Location Image Map page is where the Customer's location is integrated with its 3D imagery of the physical building. This page includes a “Panel Bar” that will open and collapse upon clicking. When opened, it will display the LIM Insert Form. When collapsed, it will hide the LIM Insert Form and has the title of “Add Location Image Map.” Under the “Panel Bar” is a grid listing all the customers in a table. It is pageable table with sortable column headers and data rows. Each row is a LIM with a unique ID provided by the camera manufacturer. In addition to the LIM data in each row there are also three buttons.
Edit button: When clicked it will disable the primary features of the LIM page with a shaded overlay and then opens a pop-up that lists all the LIM properties in an editable form.
Delete Button: When clicked it will prompt the user to verify that the user want to delete the LIM. If the user clicks “OK,” it will mark the LIM as deleted in the database. Nothing is deleted; just hidden. If the user clicks “Cancel,” it will return the user to the normal screen.
“Update Map” Button: When clicked it will take the user to that LIM's settings page. Next to the “Update Map” button in the table there is a “Map Updated” property showing whether the map is ready to view online.

Also on the page is a link to open the location's document library. This will take the user to another page with a web-based file explorer.

Form Properties:
Name—Textbox, Alpha-Numeric, Required, Sortable
Matterport Token—When a location is shot with Matterport camera systems, the captured imagery is uploaded to their service. In return, Matterport provides a token to that specific location's imagery. Textbox, Alpha-Numeric, Required, Sortable
Grid Order—Textbox, Numeric, Required, Sortable
Thumbnail Icon—On the customer's LIM page for this location if there are multiple LIMs it will use the Thumbnail icons that the user uploads for each LIM to quickly switch between the different image sets. File Upload UI Component, Optional
Blueprint/Map—For each LIM there will be a blueprint/mini-map showing the user where they are in the main 3D version of the LIM. The camera manufacturer provides, through their API, a location spot for each time the camera took imagery. Those spots will show up on the blueprint/mini-map, and the user will be able to click on the little dots to transport from spot to spot without having to “walk-through” the LIM. There is also a dot for the user's current location inside the 3D LIM with a vision cone to show direction. This is the image the 3D LIM will use to place the quick transport dots and current user position. File Upload UI Component, Optional

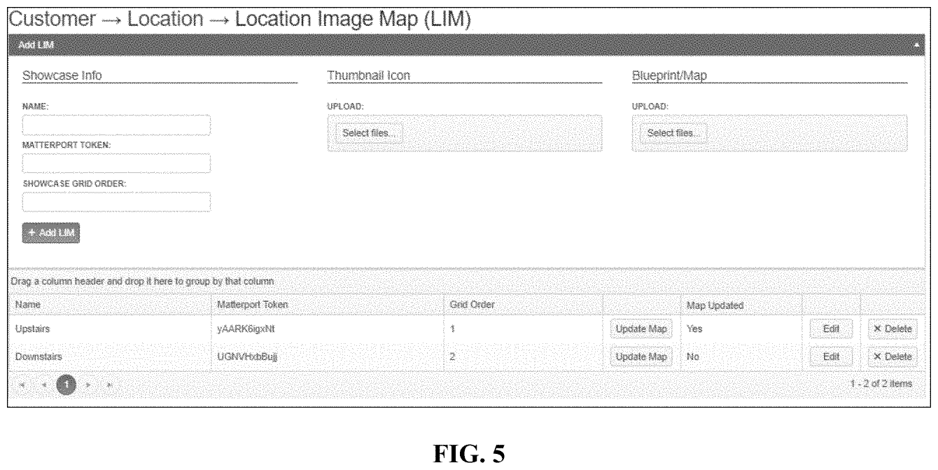

LIM Page Panel Bar, Insert Form, and Grid. This Razor page (view) has been built inside of a shared view so that it can use the application's master header, menu, and footer. This page also has a corresponding method inside its controller. The method in the controller checks to see if the user is authenticated, has permissions, and sets a ViewBag with the Location's Id. The method in the controller uses C#. The view uses HTML, C#, CS S, JavaScript, jQuery, and Angular to build out the panel bar, insert form, and grid as shown in FIG. 5. The panel bar is a Kendo Panal Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers and create events that are stored inside the HTML DOM.

Activating Kendo UI Controllers. Activates input items such as textboxes, html editors, and grids. When the grid is activated, a data source is set to a method inside the controller that returns the list of LIMs as a JSON object. While creating the LIM object it checks to see if the Map has been set up properly. This check adds a green “Yes” or red “No” to the “Map Updated” property. Properties for the grid are also defined. Examples of properties are width, pageable, scrollable, editable, etc.

Events. “Add LIM” Button Click—When clicked, it will create variables for each input item and assigns it the value of the Angular scope property on that input item. Then each input value is added to a JSON string using the JSON. Stringify method. Once the string is set as JSON, it posts that data to a method inside the CustomerController called “AddLIM.” The AddCustomer method serializes the JSON string into a LocationImageMap model object. Once it is an object, it is inserted into the database using the Data Project. The results are passed back to the view and a message is displayed informing the user the results.

LIM “Edit” Button Click—The “Edit” event will build out the form using a popup editor fired inside the script tag using a Kendo template. The system will load the data of the row from which the click fired into textboxes and other input items. Once the LIM is edited, it will post that data to the controller and the controller will serialize the data into a customer object and then update the row in the database using the Data Project.

LIM “Delete” Button Click—When clicked, it will fire the destroy method inside the grid. That will post the object to the destroy method in the controller and mark that LIM as deleted. It will not actually remove any records from the database.

“Update Map” Button Click—The “Update Map” button event will take the user to the location view with the LIM Id.

Map Settings Page. The Map settings page allows an administrator to align the camera location dots provided by the camera manufacturer with the blueprint/mini-map that was uploaded by the administrator. This page uses the Location Image Map Id to get its specific Matterport Token from the application database. It then runs a script to add the Matterport Token to the iFrame to load the 3D Image Map from the Matterport Service. Inside of the Location Image Map (LIM), in the top-right corner, is the uploaded blueprint/mini-map with its camera location dots and the current user's field of view. To the left are four numeric textboxes that allow the administrator to change the location of the top-left corner and height/width of the element housing the camera location views. Once the values are correct and the mini-map is lined up with the 3D Image map, the “Update Values” button can be clicked.

Form Properties:
Width: Numeric Textbox, required—This will manipulate the width of the element that is storing the camera location dots. This will save as pixels or percentage.
Height: Numeric Textbox, required—This will manipulate the height of the element that is storing the camera location dots. This will save as a percentage.
Left: Numeric Textbox, required—This will manipulate the left side starting point of the element that is storing the camera location dots. This will save a percentage.
Top: Numeric Textbox, required—This will manipulate the top of the element that is storing the camera location dots. This will save as a percentage.

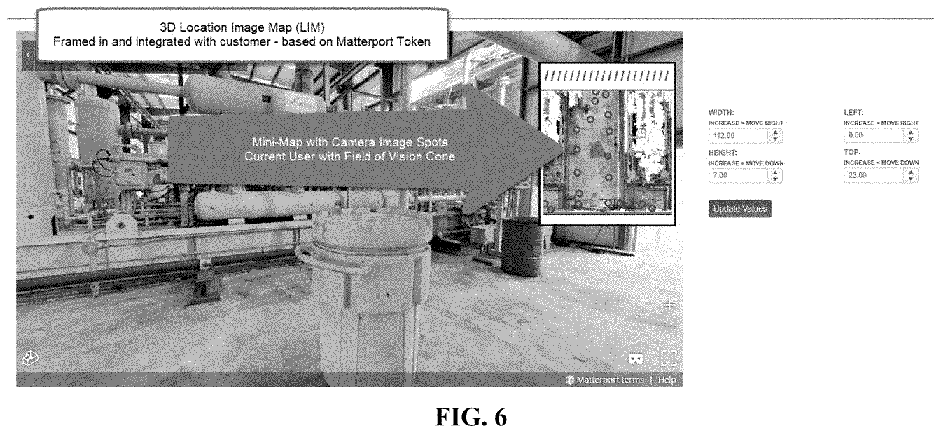

This Razor page (view) has been built inside of a shared view so that it can use the application's master header, menu, and footer. This page also has a corresponding method inside its controller. The method in the controller checks to see if the user is authenticated, has permissions, and sets a few ViewBags with the LIM Information, Matterport Token, and File Path to the Blueprint/Mini-Map. The method in the controller uses C#. The view uses HTML, C#, CSS, JavaScript, jQuery, and Angular to create the map settings form, frame the LIM from the camera manufacturer's service, and build the mini-map that is integrated with the camera image spots as showing in FIG. 6. When the page loads, it will activate the Kendo UI Controllers and populate the textboxes with either default values or it will make an ajax call to the server and request those values. When it retrieves the values from the application database, it will populate the textbox values and set the scope property for each. Next, it makes a connection to the camera manufacture's API to retrieve the 3D Image Object. That object provides the camera location dots, the current location of the user, and asset tags. With the location of the user and the dimensions of the 3D image field of view, the field of vision cone of the current user can be calculated. The cone is built with a simple div and CSS. When the user looks around it changes the properties of the CSS to match with what the user is seeing in the 3D Image Map.

Activating Kendo UI Controllers. Activates textboxes and button.

Events. Setting up 3D Image Map. A ViewBag object for the Matterpoint Token is passed in. A script runs when the page loads that will edit the source attribute on the iFrame that points to the right 3D Image Map.

Setting up blueprint/mini-map. A ViewBag object for the image location for the blueprint/mini-map is passed in. The ViewBag object is used directly in the HTML using C# Razor.

Loading the camera location spots. A connection is created to the camera manufacturer's API and the object using the Matterport Token is requested. The location of all the Camera Image Spots and the view dimensions of the current user's location are returned. The Camera Location Spot element are layered above the blueprint/mini-map. At first the dots will not line up properly until the user updates the size and location textboxes.

Update the element location and size of the camera location spots. Four textboxes to the left of the 3D image map will allow the user to move and re-size the camera location spots that were sent to the view by the camera manufacturer's API. The div that stores the element for the camera locations spots has a top, left, height, and width specified in-line with the element. When changing the value in the textboxes it calls a “Change” event in the JavaScript and that updates those CSS Attributes on the fly so that the user can see their work in progress.

“Update Values” Button Click—When clicked it creates variables and updates the scope of each textbox value. Then each value is added to a JSON string using the JSON.Stringify method. Once the string is set as JSON then it posts that data to a method inside the CustomerController called “UpdateMapValues.” The “UpdateMapValues” method serializes the JSON string into a customer model object. Once it is an object, it is inserted into the database using the Data Project. The results are passed back to the view and a message is displayed informing the user the results.

Changing the Field of View cone for the current user that is in the blueprint/mini-map. Using the existing 3D Image object, the field of view that is displaying on the screen can be determined. The field of view is stored as numbers/dimensions. Those dimensions can be taken and, with a calculation, be used to determine the field of view cone on the blueprint/mini-map. The cone is a div with CSS properties. Whenever the field of vision moves, an event is called that updates the calculation and changes the CSS to match.

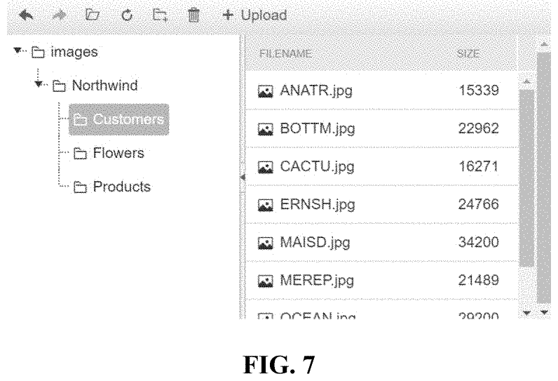

Centralized Document Control Page. This page allows a logged in user to manage their location documents in a web-based file explorer. The user will be able to manage their documents in a web-based file explorer that is very similar to the file explorer they are used to using on their desktop computer. The file explorer contains a toolbar and two windows that gives the user a visual of their file tree and documents as shown in FIG. 7. The toolbar includes options to change folders, add folders, refresh the windows, delete files, and upload new files. The window on the left is a tree view of their folder structure. Clicking on a folder will change the file list in the right window to show what files are in that folder. Each file can be double-clicked to open in a new tab.

Web-based Document Library. This Razor page (view) has been built inside of a shared view so that it can use the application's master header, menu, and footer. This page also has a corresponding method inside its controller. The method in the controller checks to see if the user is authenticated. The method in the controller uses C#. The view uses HTML, C#, and JavaScript.

Activating Controllers. Activates the iFrame.

Events. DataSource—On page load, a request is made to the database and based on the logged in user's LocationID it will return a DocumentLibraryID. The document libraryID will be used to populate the iFrame that will then open a view to the location's document library.

Additional pages may be included to provide enhanced functionality such as GPS tracking device integration. GPS tracking devices may be assigned to customer employees, customer guest, and external organization employees. The device communicate with the device manufacture's server, and the system will request the data via the manufacturer's API.

Guest Setup and Device Assignment Page. This page includes a “Panel Bar” that will open and collapse upon clicking showing the Guest insert form. Under the “Panel Bar” is a grid listing all a user's guests in a table. It is pageable table with sortable column headers and data rows. Each row is a customer guest account. In addition to the guest data in each row there are also two buttons.
Edit button: When clicked it will disable the primary features of the customer guest page with a shaded overlay and then opens a pop-up that lists all the guest's properties in an editable form.
Delete Button: When clicked it will prompt the user to verify that the user wants to delete the guest. If the user clicks “OK,” it will mark the guest as deleted in the database. Nothing is deleted, just hidden. If the user clicks “Cancel,” it will return the user to the normal screen.

Form Properties:
First Name—Textbox, Alpha-Numeric, Required, Filterable by Text, Sortable
Last Name—Textbox, Alpha-Numeric, Required, Filterable by Text, Sortable
Reason for Visit—It will store this data in HTML format built by a WYSIWYG Editor. Optional
Address 1—Textbox, Alpha-Numeric, Required, Sortable
Address 2—Textbox, Alpha-Numeric, Optional, Sortable
City—Textbox, Alpha-Numeric, Required, Sortable
State—Dropdown containing all 50 States and Washington DC, Alpha-Numeric, Required, Sortable
Zip Code—Textbox, Alpha-Numeric, Required, Sortable
Phone Number—Masked Textbox, Numeric, Required, Sortable
Email Address—Textbox, Alpha-Numeric, Optional, Sortable
Picture—This will be uploaded to the server and used in reports. File Upload UI Component, Optional
GPS Device ID—Numeric Textbox, Numbers, Optional
Bluetooth Low Energy (BLE) Device Model—Dropdown, Optional
BLE Device ID—Numeric Textbox, Numbers, Optional
Guest Information Card—It will store this data in HTML format built by a WYSIWYG Editor. Optional
Guest Certifications—It will store this data in HTML format built by a WYSIWYG Editor. Optional
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. Guest Grid—a data source is set to a method inside the controller that returns the list of customer guests as a JSON object. If the guest has an active device, it will order them at the top, with a different color, and show the latest GPS Points. Other properties for the grid are also defined. Examples of properties are width, pageable, scrollable, editable, etc.

Events. Insert form Button Click—When clicked, it creates variables for each input item and assigns it the value of the Angular scope property on that input item. Then each input value is added to a JSON string using the JSON.Stringify method. Once the string is set as JSON then it posts that data to a method inside the CustomerController called “AddCustomerGuest.” The AddCustomerGuest method serializes the JSON string into an organization user class object. Once it is an object, it is inserted into the database using Entity Framework. The results are passed back to the view and a message is displayed informing the user the results.

Customer Guest Edit Button Click—The “Edit” event will build out the form using a popup editor fired inside the script tag using a Kendo template. The system will load the data of the row from which the click fired into textboxes and other input items. Once the guest is edited, it will post that data to the controller and the controller will serialize the data into a guest object and then update the row in the database using Entity Framework.

Customer Guest Delete Button Click—When clicked it will fire the destroy method inside the grid. That will post the object to the destroy method in the controller and mark that customer guest as deleted. It will not actually remove any records from the database.

Customer Guest Check-in—If the customer guest is already in the system all, the user can find the customer guest in the grid and click the check-in button. This will pop open a new window that has a textbox where the admin can type or scan the GPS Device ID.

Customer Guest Checkout—When clicked it will remove the GPS Device ID from the guest and return that row the default color.

Restricted Areas Page. This page includes a “Panel Bar” that will open and collapse upon clicking showing the Restricted Area insert form. Under the “Panel Bar” is a grid listing all the buildings in a table. It is pageable table with sortable column headers and data rows. Each row is a building object. In addition to the restricted area, data in each row there are also two buttons. This feature also has a page that allows the user to assign either a user or organization to the restricted areas.
Edit button: When clicked it will disable the primary features of the restricted areas management page with a shaded overlay and then opens a pop-up that lists all the restricted area's properties in an editable form.
Delete Button: When clicked it will prompt the user to verify that the user wants to delete the restricted area. If the user clicks “OK” it will mark the restricted area as deleted in the database. Nothing is deleted; just hidden. If the user click “Cancel” it will return the user to the normal screen.
User and Organization Assignment Page: This is a page where the administrator can go in and assign their users, external organization users, or whole organizations to a specific restricted area. The admin will see a list of users and organizations in which they will check a box to include in this restricted area. If anybody on this list goes into the restricted area it will notify the appropriate contacts via a text message. The restricted area alert will clear when the device leaves that area.

Form Properties:
Restricted Area Name—Textbox, Alpha-Numeric, Required, Filterable by Text, Sortable
Feature Geometry Coordinates (List of latitude and longitude points around the building)
Textbox, comma delimited, Required
Notes—It will store this data in HTML format built by a WYSIWYG Editor. Optional
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids

Restricted Areas Grid—a data source is set to a method inside the controller that returns the list of restricted areas as a JSON object. Properties for the grid are also defined. Examples of properties are width, pageable, scrollable, editable, etc.

Events. Insert Form Button Click—When clicked it create variables for each input item and assigns it the value of the Angular scope property on that input item. Then each input value is added to a JSON string using the JSON.Stringify method. Once the string is set as JSON then it posts that data to a method inside the CustomerController called “AddRestrictedArea.” The AddRestrictedArea method serializes the JSON string into a Restricted Area class object. Once it is an object, it is inserted into the database using Entity Framework. The results are passed back to the view and a message is displayed informing the user the results.

Restricted Area Edit Button Click—The “Edit” event will build out the form using a popup editor fired inside the script tag using a Kendo template. The system will load the data of the row from which the click fired into textboxes and other input items. Once the restricted area is edited, it will post that data to the controller and the controller will serialize the data into a restricted area object and then update the row in the database using Entity Framework.

Restricted Area Delete Button Click—When clicked it will fire the destroy method inside the grid. That will post the object to the destroy method in the controller and mark that restricted area as deleted. It will not actually remove any records from the database.

Bluetooth Low Energy (BLE) Beacons Integration. BLE beacons will be installed inside of a building and used with Bluetooth tags to track personnel and other trackable objects. This would be optimal if there are multiple stories in a building or GPS connectivity is too weak. This feature will involve including the following pages: Building Management and Tag Assignments.

Building Management Page. This page includes a “Panel Bar” that will open and collapse upon clicking showing the building insert form. Under the “Panel Bar” is a grid listing all the buildings in a table. It is pageable table with sortable column headers and data rows. Each row is a building object. In addition to the building data in each row, there are also two buttons.
Edit button: When clicked it will disable the primary features of the building management page with a shaded overlay and then opens a pop-up that lists all the user's properties in an editable form.
Delete Button: When clicked it will prompt the user to verify that the user wants to delete the building. If the user clicks “OK” it will mark the building as deleted in the database. Nothing is deleted, just hidden. If the user click “Cancel” it will return the user to the normal screen.

Form Properties:
Building Name—Textbox, Alpha-Numeric, Required, Filterable by Text, Sortable
Feature Geometry Coordinates (List of latitude and longitude points around the building)
Textbox, comma delimited, Required
Blueprint Image—This will be uploaded to the server and used in reports. File Upload UI Component
Latitude—Numeric Textbox, Numbers, Required
Longitude—Numeric Textbox, Numbers, Required
Notes—It will store this data in HTML format built by a WYSIWYG Editor. Optional
Enable BLE—Boolean, Required, Filterable, Sortable
BLE Building API ID—Textbox, Alpha-Numeric, required if BLE is enabled, Filterable by Text, Sortable
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. Building Grid—a data source is set to a method inside the controller that returns the list of buildings as a JSON object. Properties for the grid are also defined. Examples of properties are width, pageable, scrollable, editable, etc.

Events. Insert form Button Click—When clicked it create variables for each input item and assigns it the value of the Angular scope property on that input item. Then each input value is added to a JSON string using the JSON.Stringify method. Once the string is set as JSON then it posts that data to a method inside the BuildingController called “AddBuilding.” The AddBuilding method serializes the JSON string into a Building class object. Once it is an object, it is inserted into the database using Entity Framework. The results are passed back to the view and a message is displayed informing the user the results.

Building Edit Button Click—The “Edit” event will build out the form using a popup editor fired inside the script tag using a Kendo template. The system will load the data of the row from which the click fired into textboxes and other input items. Once the building is edited, it will post that data to the controller and the controller will serialize the data into a building object and then update the row in the database using Entity Framework.

Building Delete Button Click—When clicked it will fire the destroy method inside the grid. That will post the object to the destroy method in the controller and mark that building as deleted. It will not actually remove any records from the database.

BLE Tag Assignments Page. This page includes a “Panel Bar” that will open and collapse upon clicking showing the BLE Tag insert form. Under the “Panel Bar” is a grid listing all the buildings in a table. It is pageable table with sortable column headers and data rows. Each row is a BLE Tag object. In addition to the BLE Tag data in each row, there are also two buttons.
Edit button: When clicked it will disable the primary features of the BLE Tag assignment page with a shaded overlay and then opens a pop-up that lists all the user's properties in an editable form.
Delete Button: When clicked it will prompt the user to verify that the user want to delete the BLE Tag. If the user clicks “OK” it will mark the BLE Tag as deleted in the database. Nothing is deleted, just hidden. If the user clicks “Cancel” it will return the user to the normal screen.

Form Properties:
BLE Tag Name—Textbox, Alpha-Numeric, Required, Filterable by Text, Sortable
Bluetooth Low Energy (BLE) Device Model—Dropdown, Optional
BLE Device ID—Numeric Textbox, Numbers, Optional
User Information Card—It will store this data in HTML format built by a WYSIWYG Editor. Optional
User Certifications—It will store this data in HTML format built by a WYSIWYG Editor. Optional
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. BLE Tag Grid—a data source is set to a method inside the controller that returns the list of BLE Tags as a JSON object. Properties for the grid are also defined. Examples of properties are width, pageable, scrollable, editable, etc.

Events. Insert form Button Click—When clicked it create variables for each input item and assigns it the value of the Angular scope property on that input item. Then each input value is added to a JSON string using the JSON.Stringify method. Once the string is set as JSON then it posts that data to a method inside the BluetoothLowEnergyController called “AddBLETag.” The AddBLETag method serializes the JSON string into a BLE Tag class object. Once it is an object, it is inserted into the database using Entity Framework. The results are passed back to the view and a message is displayed informing the user the results.

BLE Tag Edit Button Click—The “Edit” event will build out the form using a popup editor fired inside the script tag using a Kendo template. The system will load the data of the row from which the click fired into textboxes and other input items. Once the BLE Tag is edited, it will post that data to the controller and the controller will serialize the data into a BLE Tag object and then update the row in the database using Entity Framework.

BLE Tag Delete Button Click—When clicked it will fire the destroy method inside the grid. That will post the object to the destroy method in the controller and mark that BLE Tag as deleted. It will not actually remove any records from the database.

Organization and External User Management. The organization and external user management features is where the external organizations, such as contractors, can register for an account and add users for GPS tracking and access. The organization will put in their payment information and be able to print off invoices as well. This feature may be embodied through including the following pages.

Registration Page. This page will look like a standard registration page that will allow the user to set up an account insert payment information. The registrant's organizations will be bill monthly for their subscriptions. This page may also include a Submit Button, which will take the user to that organization's user screen when clicked.

Registration Form Properties:
Name—Textbox, Alpha-Numeric, Required
Account Number—This will be manually assigned to fit the current organization identification scheme. Textbox, Alpha-Numeric, Required
Address 1—Textbox, Alpha-Numeric, Required
Address 2—Textbox, Alpha-Numeric, Optional
City—Textbox, Alpha-Numeric, Required
State—Dropdown containing all 50 States and Washington DC, Alpha-Numeric, Required
Zip Code—Textbox, Alpha-Numeric, Required
Phone Number—Masked Textbox, Numeric, Required
Primary Contact Name—This is the full name of the primary contact with the organization. Textbox, Alpha-Numeric, Optional
Primary Content Email Address—Textbox, Alpha-Numeric, Optional
Primary Account Password—Masked Textbox, Alpha-Numeric, Required
Primary Contact Phone Number—Textbox, Alpha-Numeric, Optional
Logo—This will be uploaded to the server and used in reports. File Upload UI Component
Notes—It will store the organization notes in HTML format WYSIWYG Editor. Optional

Payment Information Form Properties:
Name on Card—Textbox, Alpha-Numeric, Required
Card Number—Masked Textbox, Numeric, Required
Expiration Month—Masked Textbox, Numeric, Required
Expiration Year—Masked Textbox, Numeric, Required
Billing info if different:
   Name—Textbox, Alpha-Numeric, Required
   Account Number—This will be manually assigned to fit the current organization identification scheme. Textbox, Alpha-Numeric, Required
   Address 1—Textbox, Alpha-Numeric, Required
   Address 2—Textbox, Alpha-Numeric, Optional
   City—Textbox, Alpha-Numeric, Required
   State—Dropdown containing all 50 States and Washington DC, Alpha-Numeric,

Required
Zip Code—Textbox, Alpha-Numeric, Required

This Razor page (view) has been built inside of a shared view so that it can use the application's master header, menu, and footer. This page also has a corresponding method inside its controller. The method in the controller uses C#. The view uses HTML, C#, CSS, JavaScript, jQuery, and Angular to build out the insert form. When the page loads, it will activate the Kendo UI Controllers and create events that are stored inside the HTML DOM.

Activating Kendo UI Controllers. Activates input items such as textboxes, dropdowns, html editors, and grids.

Events. Insert form Button Click—When clicked it create variables for each input item and assigns it the value of the Angular scope property on that input item. Then each input value is added to a JSON string using the JSON.Stringify method. Once the string is set as JSON then it posts that data to a method inside the OrganizationController called “AddOrganization.” The AddOrganization method serializes the JSON string into an organization class object. Once it is an object, it is inserted into the database using Entity Framework. The results are passed back to the view and a message is displayed informing the user the results.

Organization's User Page. This page includes a “Panel Bar” that will open and collapse upon clicking showing the user insert form, an “Edit” link to modify any of the organization's properties or payment information, and a link to cancel the organization's account. Under the “Panel Bar” is a grid listing all the organization users in a table. It is pageable table with sortable column headers and data rows. Each row is an organization user. In addition to the customer data in each row, there are also two buttons.
Edit button: When clicked it will disable the primary features of the organization user page with a shaded overlay and then opens a pop-up that lists all the user's properties in an editable form.
Delete Button: When clicked it will prompt the user to verify that the user wants to delete the user. If the user clicks “OK” it will mark the user as deleted in the database. Nothing is deleted, just hidden. If the user clicks “Cancel,” it will return the user to the normal screen.

Form Properties:
First Name—Textbox, Alpha-Numeric, Required, Filterable by Text, Sortable
Last Name—Textbox, Alpha-Numeric, Required, Filterable by Text, Sortable
Customer User Number—This will be manually assigned to fit the organization's identification scheme. Textbox, Alpha-Numeric, Required, Filterable by Text, Sortable
Address 1—Textbox, Alpha-Numeric, Required, Sortable
Address 2—Textbox, Alpha-Numeric, Optional, Sortable
City—Textbox, Alpha-Numeric, Required, Sortable
State—Dropdown containing all 50 States and Washington DC, Alpha-Numeric, Required, Sortable
Zip Code—Textbox, Alpha-Numeric, Required, Sortable
Phone Number—Masked Textbox, Numeric, Required, Sortable
Email Address—Textbox, Alpha-Numeric, Optional, Sortable
Picture—This will be uploaded to the server and used in reports. File Upload UI Component, Optional
GPS Device ID—Numeric Textbox, Numbers, Optional
Bluetooth Low Energy (BLE) Device Model—Dropdown, Optional
BLE Device ID—Numeric Textbox, Numbers, Optional
User Information Card—It will store this data in HTML format built by a WYSIWYG Editor. Optional
User Certifications—It will store this data in HTML format built by a WYSIWYG Editor. Optional
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. User Grid—a data source is set to a method inside the controller that returns the list of organization users as a JSON object. Properties for the grid are also defined. Examples of properties are width, pageable, scrollable, editable, etc. Payment Invoice Grid—When a payment is posted by the payment gateway service provider, they will send the results of the payment to the API and that data will be put in the database. The invoice gird's data source is set to a method inside the controller that returns the list of invoices as a JSON object. Properties for the grid are also defined. Examples of properties are width, pageable, scrollable, editable, etc. The invoice number will be a link that will open a print window for that specific invoice.

Events. Insert form Button Click—When clicked it create variables for each input item and assigns it the value of the Angular scope property on that input item. Then each input value is added to a JSON string using the JSON.Stringify method. Once the string is set as JSON then it post that data to a method inside the OrganizationController called “AddOrganizationUser.” The AddOrganizationUser method serializes the JSON string into an organization user class object. Once it is an object, it will be inserted into the database using Entity Framework. The results are passed back to the view and a message is displayed informing the user the results.

Organization User Edit Button Click—The “Edit” event will build out the form using a popup editor fired inside the script tag using a Kendo template. The system will load the data of the row from which the click fired into textboxes and other input items. Once the organization is edited, it will post that data to the controller and the controller will serialize the data into an organization object and then update the row in the database using Entity Framework.

Organization User Delete Button Click—When clicked it will fire the destroy method inside the grid. That will post the object to the destroy method in the controller and mark that organization user as deleted. It will not actually remove any records from the database.

Camera Feed Management Page. From this page the customer will manage the camera feed objects on its property map. There will be a radio button at the top to switch in between the different camera systems. The different camera systems available include:
Stationary CCTV Camera
Mobile Camera Feed System
Body Cam Systems
License Plate Scanner

Stationary CCTV Cameras Page. This page includes a “Panel Bar” that will open and collapse upon clicking showing the camera feed insert form. Under the “Panel Bar” is a grid listing all the camera feeds in a table. It is pageable table with sortable column headers and data rows. Each row is a camera feed object. In addition to the camera feed data in each row, there are also two buttons.
Edit button: When clicked it will disable the primary features of the camera feed management page with a shaded overlay and then opens a pop-up that lists all the user's properties in an editable form.
Delete Button: When clicked it will prompt the user to verify that the user wants to delete the camera. If the user clicks “OK” it will mark the camera feed as deleted in the database. Nothing is deleted, just hidden. If the user clicks “Cancel” it will return the user to the normal screen.

Form Properties:
Camera Feed Name—Textbox, Alpha-Numeric, Required, Filterable by Text, Sortable
Camera Serial Number—This will be manually assigned to fit the organization's identification scheme. Textbox, Alpha-Numeric, Required, Filterable by Text, Sortable
Camera Model—Dropdown, Required, Filterable by Text, Sortable
Latitude—Numeric Textbox, Numbers, Required
Longitude—Numeric Textbox, Numbers, Required
Notes—It will store this data in HTML format built by a WYSIWYG Editor. Optional
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. Camera Feed Grid—a data source is set to a method inside the controller that returns the list of camera feeds as a JSON object. Properties for the grid are also defined. Examples of properties are width, pageable, scrollable, editable, etc.

Events. Insert form Button Click—When clicked it create variables for each input item and assigns it the value of the Angular scope property on that input item. Then each input value is added to a JSON string using the JSON.Stringify method. Once the string is set as JSON then it posts that data to a method inside the CameraFeedController called “AddCameraFeedStationaryCCTV.” The AddCameraFeedStationaryCCTV method serializes the JSON string into a Camera Feed Stationary CCTV class object. Once it is an object, it is inserted into the database using Entity Framework. The results are passed back to the view and a message is displayed informing the user the results.

Camera Feed Edit Button Click—The “Edit” event will build out the form using a popup editor fired inside the script tag using a Kendo template. The system will load the data of the row from which the click fired into textboxes and other input items. Once the camera feed is edited, it will post that data to the controller and the controller will serialize the data into an organization object and then update the row in the database using Entity Framework.

Camera Feed Delete Button Click—When clicked it will fire the destroy method inside the grid. That will post the object to the destroy method in the controller and mark that r as deleted. It will not actually remove any records from the database.

Mobile Camera Feed Systems with GPS Page. This page includes a “Panel Bar” that will open and collapse upon clicking showing the mobile camera feed insert form. Under the “Panel Bar” is a grid listing all the mobile camera feeds in a table. It is pageable table with sortable column headers and data rows. Each row is a mobile camera feed object. In addition to the mobile camera feed data in each row there are also two buttons.
Edit button: When clicked it will disable the primary features of the mobile camera feed management page with a shaded overlay and then opens a pop-up that lists all the user's properties in an editable form.
Delete Button: When clicked it will prompt the user to verify that the user wants to delete the mobile camera. If the user clicks “OK” it will mark the mobile camera feed as deleted in the database. Nothing is deleted, just hidden. If the user clicks “Cancel” it will return the user to the normal screen.

Form Properties:
Mobile Camera Feed Name—Textbox, Alpha-Numeric, Required, Filterable by Text, Sortable
Mobile Camera Serial Number—This will be manually assigned to fit the organization's identification scheme. Textbox, Alpha-Numeric, Required, Filterable by Text, Sortable
Mobile Camera Model—Dropdown, Required, Filterable by Text, Sortable
Notes—It will store this data in HTML format built by a WYSIWYG Editor. Optional
Latitude—Updated via a Windows service that request the information from the manufacture API
Longitude—Updated via a Windows service that request the information from the manufacture API
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. Mobile Camera Feed Grid—a data source is set to a method inside the controller that returns the list of camera feeds as a JSON object. Properties for the grid are also defined. Examples of properties are width, pageable, scrollable, editable, etc.

Events. Insert form Button Click—When clicked it create variables for each input item and assigns it the value of the Angular scope property on that input item. Then each input value is added to a JSON string using the JSON.Stringify method. Once the string is set as JSON then it posts that data to a method inside the CameraFeedController called “AddCameraFeedMobile.” The AddCameraFeedMobile method serializes the JSON string into a Mobile Camera Feed class object. Once it is an object, it is inserted into the database using Entity Framework. The results are passed back to the view and a message is displayed informing the user the results.

Mobile Camera Feed Edit Button Click—The “Edit” event will build out the form using a popup editor fired inside the script tag using a Kendo template. The system will load the data of the row from which the click fired into textboxes and other input items. Once the mobile camera feed is edited, it will post that data to the controller and the controller will serialize the data into an organization object and then update the row in the database using Entity Framework.

A Windows service will update the GPS location of the mobile camera feed systems by requesting the data from the mobile camera manufacturer API. Once the page has been opened, it will check the database for the latest points that are reported.

Mobile Camera Feed Delete Button Click—When clicked it will fire the destroy method inside the grid. That will post the object to the destroy method in the controller and mark that r as deleted. It will not actually remove any records from the database.

Body Cam Systems with GPS Page. This page includes a “Panel Bar” that will open and collapse upon clicking showing the body cam feed insert form. Under the “Panel Bar” is a grid listing all the body cam feeds in a table. It is pageable table with sortable column headers and data rows. Each row is a body cam feed object. In addition to the body cam feed data in each row, there are also two buttons.
Edit button: When clicked it will disable the primary features of the body cam feed management page with a shaded overlay and then opens a pop-up that lists all the user's properties in an editable form.
Delete Button: When clicked it will prompt the user to verify that the user wants to delete the body cam. If the user clicks “OK” it will mark the body cam feed as deleted in the database. Nothing is deleted; just hidden. If the user clicks “Cancel” it will return the user to the normal screen.

Form Properties:
Body Cam Feed Name—Textbox, Alpha-Numeric, Required, Filterable by Text, Sortable
Body Cam Serial Number—This will be manually assigned to fit the organization's identification scheme. Textbox, Alpha-Numeric, Required, Filterable by Text, Sortable
Body Cam Model—Dropdown, Required, Filterable by Text, Sortable
Notes—It will store this data in HTML format built by a WYSIWYG Editor. Optional
Latitude—Updated via a Windows service that request the information from the manufacture API
Longitude—Updated via a Windows service that request the information from the manufacture API
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. Body Cam Feed Grid—a data source is set to a method inside the controller that returns the list of camera feeds as a JSON object. Properties for the grid are also defined. Examples of properties are width, pageable, scrollable, editable, etc.

Events. Insert form Button Click—When clicked it create variables for each input item and assigns it the value of the Angular scope property on that input item. Then each input value is added to a JSON string using the JSON.Stringify method. Once the string is set as JSON then it posts that data to a method inside the CameraFeedController called “AddCameraFeedBodyCam.” The AddCameraFeedBodyCam method serializes the JSON string into a Body Cam Feed class object. Once it is an object, it is inserted into the database using Entity Framework. The results are passed back to the view and a message is displayed informing the user the results.

Body Cam Feed Edit Button Click—The “Edit” event will build out the form using a popup editor fired inside the script tag using a Kendo template. The system will load the data of the row from which the click fired into textboxes and other input items. Once the body cam feed is edited, it will post that data to the controller and the controller will serialize the data into an organization object and then update the row in the database using Entity Framework.

A Windows service will update the GPS location of the body cam feed systems by requesting the data from the body cam manufacturer API. Once the page has been opened, it will check the database for the latest points that are reported.

Body Cam Feed Delete Button Click—When clicked it will fire the destroy method inside the grid. That will post the object to the destroy method in the controller and mark that r as deleted. It will not actually remove any records from the database.

License Plate Scanner (LPS) with Alerts Page. This page includes a “Panel Bar” that will open and collapse upon clicking showing the license plate scanner insert form. Under the “Panel Bar” is a grid listing all the license plate scanners in a table. It is pageable table with sortable column headers and data rows. Each row is an LPS object. In addition to the LPS data in each row, there are also two buttons.
Edit button: When clicked it will disable the primary features of the LPS management page with a shaded overlay and then opens a pop-up that lists all the user's properties in an editable form.
Delete Button: When clicked, it will prompt the user to verify that the user wants to delete the LPS. If the user clicks “OK” it will mark the LPS as deleted in the database. Nothing is deleted, just hidden. If the user clicks “Cancel” it will return the user to the normal screen.

Form Properties:
LPS Name—Textbox, Alpha-Numeric, Required, Filterable by Text, Sortable
LPS Serial Number—This will be manually assigned to fit the organization's identification scheme. Textbox, Alpha-Numeric, Required, Filterable by Text, Sortable
LPS Model—Dropdown, Required, Filterable by Text, Sortable
Notes—It will store this data in HTML format built by a WYSIWYG Editor. Optional
Latitude—Masked Textbox, Numeric, Required, Filterable by Text, Sortable
Longitude—Masked Textbox, Numeric, Required, Filterable by Text, Sortable
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. LPS Grid—a data source is set to a method inside the controller that returns the list of LPS feeds as a JSON object. Properties for the grid are also defined. Examples of properties are width, pageable, scrollable, editable, etc.

Events. Insert form Button Click—When clicked it create variables for each input item and assigns it the value of the Angular scope property on that input item. Then each input value is added to a JSON string using the JSON.Stringify method. Once the string is set as JSON then it posts that data to a method inside the CameraFeedController called “AddCameraFeedLPS.” The AddCameraFeedLPS method serializes the JSON string into an LSP class object. Once it is an object, it is inserted into the database using Entity Framework. The results are passed back to the view and a message is displayed informing the user the results.

LPS Edit Button Click—The “Edit” event will build out the form using a popup editor fired inside the script tag using a Kendo template. The system will load the data of the row from which the click fired into textboxes and other input items. Once the LPS is edited, it will post that data to the controller and the controller will serialize the data into an organization object and then update the row in the database using Entity Framework.

LPS Delete Button Click—When clicked it will fire the destroy method inside the grid. That will post the object to the destroy method in the controller and mark that LPS as deleted. It will not actually remove any records from the database.

Third Party Integration with Database. When the LPS captures a license plate number, it will log that event (via a post from the device manufacturing API) into the database. These logs can be viewed and reported from the LPS log page. When on the LPS log page it will display the events in a grid with sortable and searchable columns. The grid will also have a date filter that can configured to default to a certain number of days.

LPS Alerts Page. This page includes a “Panel Bar” that will open and collapse upon clicking showing the license plate scanner alerts insert form. Under the “Panel Bar” is a grid listing all the license plate scanners in a table. It is pageable table with sortable column headers and data rows. Each row is an LPS Alert object. In addition to the LPS Alert data in each row, there are also two buttons.
Edit button: When clicked it will disable the primary features of the LPS Alert management page with a shaded overlay and then opens a pop-up that lists all the user's properties in an editable form.
Delete Button: When clicked, it will prompt the user to verify that the user wants to delete the LPS Alert. If the user clicks “OK” it will mark the LPS Alert as deleted in the database. Nothing is deleted, just hidden. If the user clicks “Cancel” it will return the user to the normal screen.

Form Properties:
LPS Alert Name—Textbox, Alpha-Numeric, Required, Filterable by Text, Sortable
License Plate Number—Textbox, Alpha-Numeric, Required, Filterable by Text, Sortable
License Plate State—Dropdown, Required, Filterable by Text, Sortable
Notes—It will store this data in HTML format built by a WYSIWYG Editor. Optional
Cell Phone Number—Textbox, Comma delimited list, Required
Active—Boolean, Required, Filterable, Sortable

This Razor page (view) has been built inside of a shared view so that it can use the application's master header, menu, and footer. This page also has a corresponding method inside its controller. The method in the controller checks to see if the user is authenticated, has permissions, and sets a ViewBag with the User's Id. The method in the controller uses C#. The view uses HTML, C#, CSS, JavaScript, jQuery, and Angular to build out the panel bar, insert form, and grids. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads, it will activate the Kendo UI Controllers, define data sources for the dropdowns, and create events that are stored inside the HTML DOM.

Activating Kendo UI Controllers. Activates input items such as textboxes, dropdowns, html editors, and grids. LPS Alert Grid—a data source is set to a method inside the controller that returns the list of LPS Alerts as a JSON object. Properties for the grid are also defined. Examples of properties are width, pageable, scrollable, editable, etc.

Events. Insert form Button Click—When clicked it create variables for each input item and assigns it the value of the Angular scope property on that input item. Then each input value is added to a JSON string using the JSON.Stringify method. Once the string is set as JSON then it posts that data to a method inside the CameraFeedController called “AddCameraFeedLPSAlert.” The AddCameraFeedLPSAlert method serializes the JSON string into an LPS Alert class object. Once it is an object, it is inserted into the database using Entity Framework. The results are passed back to the view and a message is displayed informing the user the results.

LPS Alert Edit Button Click—The “Edit” event will build out the form using a popup editor fired inside the script tag using a Kendo template. The system will load the data of the row from which the click fired into textboxes and other input items. Once the LPS Alert is edited, it will post that data to the controller and the controller will serialize the data into an organization object and then update the row in the database using Entity Framework.

LPS Alert Delete Button Click—When clicked it will fire the destroy method inside the grid. That will post the object to the destroy method in the controller and mark that LPS Alert as deleted. It will not actually remove any records from the database.

The system may also include the following pages to enhance its functionality.

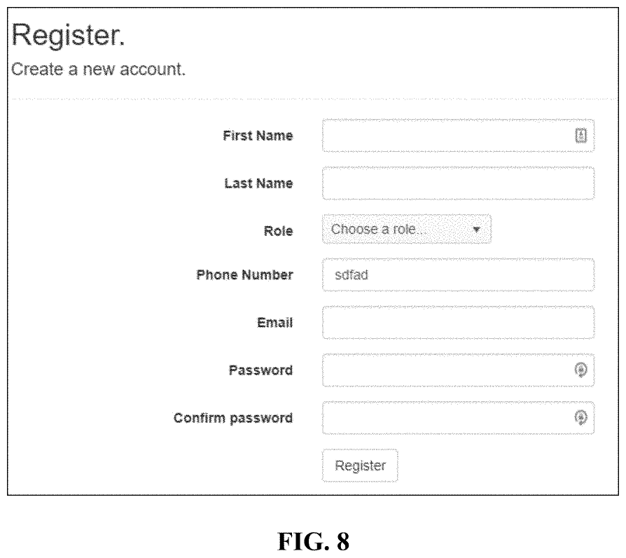

Register User Page. This page will allow an administrator to set up a new user. This page includes a standard HTML form, shown in FIG. 8, and one button to submit the data to the server. Submit Button: When clicked it will post the form data to the server and, once processed, will insert the new user in the database. There are two possible roles two choose from.
Admin: Has administrative permissions throughout the application.
Location User: Only has access to the list of locations and corresponding Location Image Maps that they are assigned.
Password Requirements: Minimum of 6 Characters, Require at least one number or special character, at least one lowercase letter, and at least one uppercase letter.

Form Properties:
First Name—Textbox, Alpha-Numeric, Required
Last Name—Textbox, Alpha-Numeric, Required
Role—Dropdown, Required
   Admin
   Location User
Phone Number—Textbox, Alpha-Numeric, Optional
Email—Textbox, Alpha-Numeric, Required. This is also the username.
Password—Password Input Item, Alpha-Numeric, Required
Confirm Password—Password Input Item, Alpha-Numeric, required—Must match “Password” field.

This Razor page (view) has been built inside of a shared view so that it can use the application's master header, menu, and footer. This page also has a corresponding method inside its controller. The method in the controller checks to see if the user is authenticated and populates a ViewBag with a list of User Roles. This ViewBag will be used to populate the “Role” dropdown. The method in the controller uses C#. The view uses HTML, C#, CSS, JavaScript, jQuery, and Angular to build out the insert form. The registration form is wrapped in a Razor BeginForm “Using” block and is tied to the RegisterViewModel assigned to the view. All input items have HTMLHelpers defining what property of the ViewModel each input item belongs to. Once submitted it will create the object using the HTMLHelper names and submit that data to the view specified in the BeginForm “Using” block. When the data gets to the Registration POST method it will create the user object, execute the Create User method with its password specified. If it successfully adds the user, it will then assign the role to that user and return the admin back to the Register page displaying a result message.

Activating Kendo UI Controllers. Activates input items such as textboxes, dropdowns.

Events. Insert Form Button Click—When clicked it will verify the password requirements, create the new user object using the data from the input items, and send that to the controller to be inserted.

Setting data source for dropdown. The “Role” dropdown in the insert form is set in the Register Controller, with a ViewBag containing a list of Roles.

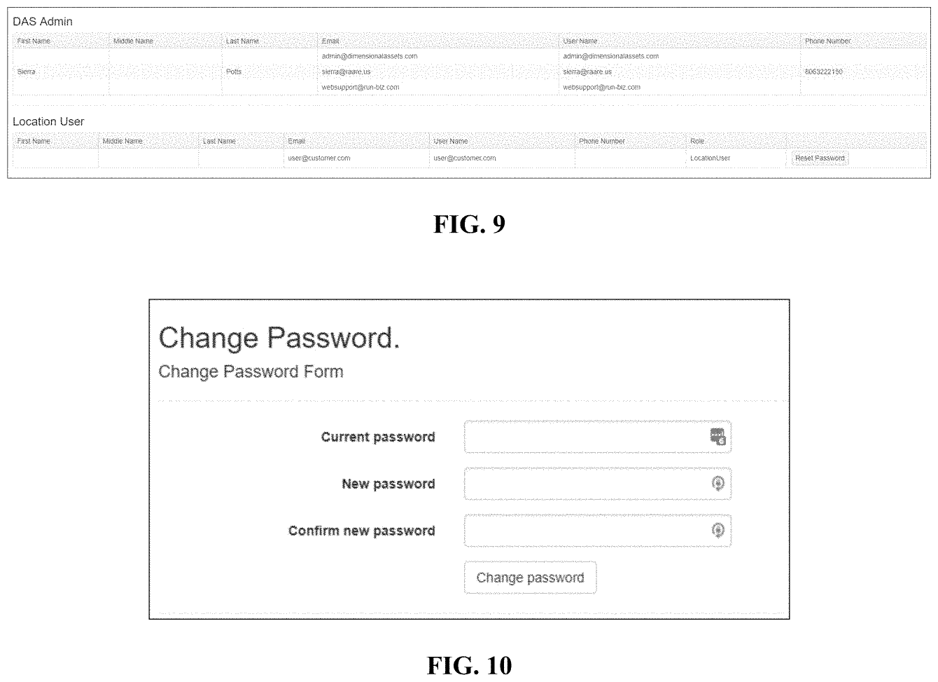

User Lists Page. This page has two list of users that are grouped by Role. A user is either an Admin or a Location User. This page has two grids, show in FIG. 9, listing users who have access to the application. If the user is in the “Admin” table then they have full permissions to the entire application and available features. If the user is a “Location User”, then they only have access to locations that have been assigned to them. Each location will have a Location Image Map (or Maps) and allow that user to digitally “walk through” each location and view asset tags.

Form Properties. This form opens when the admin clicks the “Reset Password” button for a “Location User.” Each user will have their own “Reset Password” button tied to their UserId.
Password—Password Input Item, Alpha-Numeric, Required
Confirm Password—Password Input Item, Alpha-Numeric, required—Must match “Password” field.

This Razor page (view) has been built inside of a shared view so that it can use the application's master header, menu, and footer. This page also has a corresponding method inside its controller. The method in the controller checks to see if the user is authenticated and has permissions to view the page. The method in the controller uses C#. The view uses HTML, C#, JavaScript, and jQuery to build out the two grids. The grids are built, defined, and populated using Kendo HTMLHelpers for Razor. Each grid is tied directly to a ViewModel for each specific role. An AdminViewModel populates the top grid and the LocationUserViewModel populates the lower grid. The columns and data sources are defined inside the razor with no JavaScript needed. Each grid has its own separate data source. Inside the Location User grid is a password reset button for each user row. When clicked it will determine what row it was fired from and get the UserId of that user. It then calls a JavaScript event to activate the Kendo Popup and allow the user to type in a new password. Once the password is verified and confirmed then it will call a method in the controller to reset that user's password. The Kendo Popup Window closes upon submission.

Events. “Reset Password” Button Click—The user can reset the password for a Location User by clicking this button. This calls a JavaScript event that grabs the row data where the button was clicked and creates a Kendo Popup Window that allows the administrator to reset the password. “Reset” Button located in the Kendo Popup window after the new password has been typed and confirmed. This posts the data to a controller method called “ResetLocationUserPassword” along with the UserId.

Reset Password Page. The page allows the currently logged in user to reset their own password. The user will type in their current password in the top box, the new password in the middle box, and confirm that password in the bottom box as shown in FIG. 10. There is a button called “Change Password” that will send the data to the controller and update the database. The new password must be a minimum of 6 Characters, at least one number or special character, at least one lowercase letter, and at least one uppercase letter.

Form Properties:
Current Password—Password Input Item, Alpha-Numeric, Required
New Password—Password Input Item, Alpha-Numeric, Required
Confirm Password—Password Input Item, Alpha-Numeric, required—Must match “Password” field.

This Razor page (view) has been built inside of a shared view so that it can use the application's master header, menu, and footer. This page also has a corresponding method inside its controller. The method in the controller checks to see if the user is authenticated. The method in the controller uses C#. The view uses HTML, C#, and JavaScript. The Change Password form is wrapped in a Razor BeginForm “Using” block and is tied to the ChangePasswordViewModel that is assigned to the view. All input items have HTMLHelpers defining what property of the ViewModel each input item belongs to. Once submitted it will create the object using the HTMLHelper names and submit that data to the action specified in the BeginForm “Using” block. When the data gets to the ChangePassword ActionResult, it will reset the user's password and redirect them back to the “Change Password” page displaying the Result Message.

Events. Change Password Button Click—When clicked it will verify the password requirements, create the ChangePasswordViewModel object using the data from the input items, and send that to the controller to be updated.

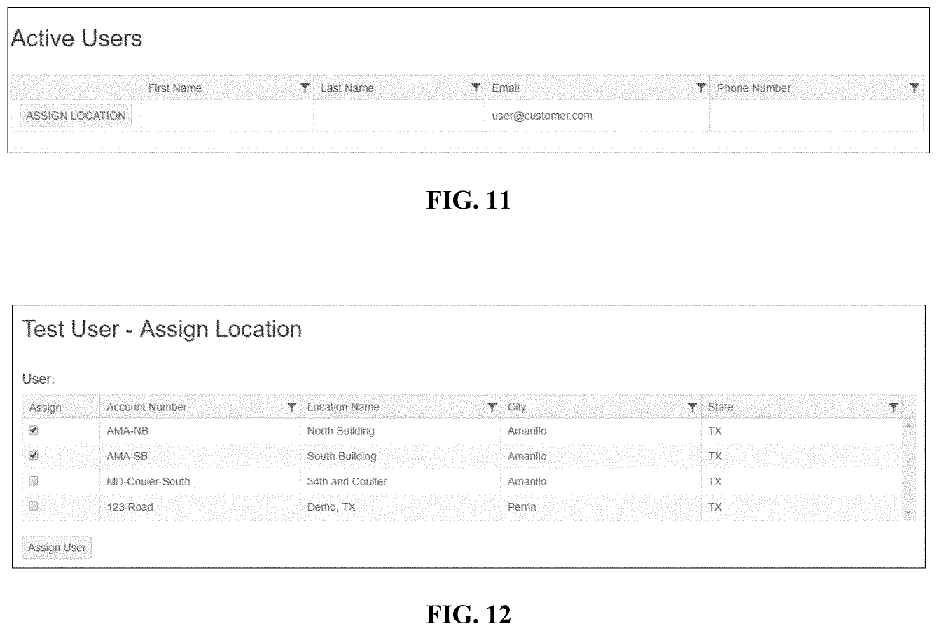

Assign Users Page. This page will list out all active Location Users and allow an administrator to assign users to a specific location. This page has a grid listing Location Users as shown in FIG. 11. For each user row in the grid, there is a button called “Assign User.” When clicked it will redirect the user to a page listing out all locations that can be assigned to that user. Each location will have a Location Image Map (or Maps) and allow that user to digitally “walk through” each location and view asset tags.

Grid columns:
“Assign Location” Button: This will take the user to a page listing out all locations with checkboxes and allow the administrator to check which location the user has permission to view.
First Name: Sortable and filterable
Last Name: Sortable and filterable
Email: Sortable and filterable
Phone Number: Sortable and filterable

This Razor page (view) has been built inside of a shared view so that it can use the application's master header, menu, and footer. This page also has a corresponding method inside its controller. The method in the controller checks to see if the user is authenticated and has permissions to view the page. The method in the controller uses C#. The view uses HTML, C#, JavaScript, and jQuery to build out the User Location grids and define the event fired by clicking the button. The grid is built, defined, and populated using Kendo HTMLHelpers for Razor. The grid is tied directly to a LocationUserViewModel and sets its data source to an ActionResult in the customer controller. That ActionResult returns a list of ViewModel objects. Inside the “Location User” grid is an “Assign Location” button for each user row. When clicked it will determine what row it was fired from and get the UserId of that user. It then redirects that user to a new page where they can assign the locations.

Event. There is a JavaScript event that is fired when the user clicks the “Assign Location” button. It grabs the current row in the grid and finds that User's ID. It then builds the URL and redirects that user to the new page.

Assign User Location Page. This page allows an administrator to assign a Location User to specific locations. When a Location User logs into the system they will only have access to the locations that have been assign to them from this page. This page includes a grid that contains a list of locations as shown in FIG. 12. In each row of the grid is a checkbox that allows the administrator to select which facilities to assign to the Location User. When the locations are selected there is a button labeled “Assign User” that will post the data to the controller and update the database.

Grid Columns:
Checkbox Column: This is an active checkbox that allows the administrator to select locations for assignment.
Account Number: Customer Account Number, Sortable, Filterable
Location Name: Sortable, Filterable
City: Sortable, Filterable
State: Sortable, Filterable

This Razor page (view) has been built inside of a shared view so that it can use the application's master header, menu, and footer. This page also has a corresponding method inside its controller. The method in the controller checks to see if the user is authenticated, has permissions, and sets a ViewBag with the UserId of the user passed to this page from the previous page. The method in the controller uses C#. The view uses HTML, C#, CSS, JavaScript, and jQuery to build out the grid and define the “Assign User” button event. The grid that uses a standard HTML div tag and will be activated in the script section of the page. The script section of this page has several roles and executes asynchronously. When the page loads, it will activate the Kendo UI Controllers, set up the Location grid, and create events that are stored inside the HTML DOM.

Activating Kendo UI Controllers. Activates the “Assign User” Button and Location grid. When the grid is activated, a data source is set to a method inside the controller that returns the list of customers as a JSON object. Properties for the grid are also defined. Examples of properties are width, pageable, scrollable, editable, etc.

Events. “Assign User” Button Click—When clicked it loops through the grid rows and checks to see if it that row is selected. If it is selected it pushes the UserId and LocationId to an array that is to be converted to JSON and submitted to the controller. The controller will serialize the Json object to a list of LocationUserLocation objects and then add them to the database. The administrator is then shown the result message on this page.

Manage Account Page. The system may also include Manage Account page configured similarly to the account-related pages described previously. Such a page may include, for example, a link for the current user to reset their own password. This page may contain standard HTML.

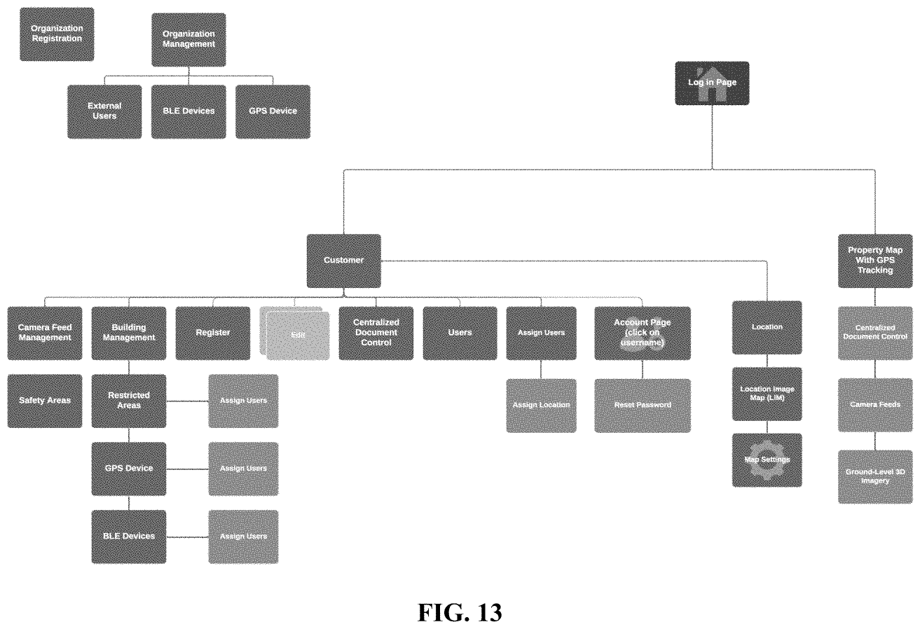

Application Development Recommendations. When building the pages described to implement the functionality of the presently described embodiment, the following development order is recommended. FIG. 13 provides additional guidance with respect to platform architecture for a system built in accordance with these recommendations and the preceding description.

Application Framework Development:
1. Create ASP .NET MVC Framework Solution.
2. Use .NET identity to handle authentication
3. Install UI Helps and Script Libraries
   a. Kendo UI
   b. jQuery
   c. NewtonSoft.Json
   d. Angular
4. Create model project to serve the Objects used by the application
5. Create data entity project to facilitate communications with Database Server
6. Create Database use Code First methodologies

Begin User Management Development:
1. Register User Form
2. User list to view, edit, and delete Users
3. Password Reset Form
4. User Account Management page for logged in user

Admin Portal Development. Each of these modules will have an insert form, grid to display the records, and each row in the grid will have an “Edit” and “Delete” button. Most of the pages will mainly consists of CRUD operations.
1. Customers
   a. Locations
      i. Assign User Locations
      ii. Location Image Maps
      iii. Map settings page
         1. Safety Areas
         2. Restricted Access Areas
         3. Building Outlines
      iv. Add Cameras
         1. Stationary CCTV Cameras
         2. Mobile Camera Systems
         3. Body Cams
         4. License Plate Scanners
   b. External Organizations
      i. Registration Page
      ii. Organization User's Page
      iii. Device Assignment
   c. Guest Setup and Device Assignments Page

Customer Portal Development. Objects entered into these forms will come together in the “Property Map with Layers” page when the customer logs into the application. The various services the application interfaces with will require the service provider or manufacture's API documentation. These Include:
Mapping Service Provider
GPS Tracking Devices Manufacturer
BLE Tracking Beacons and Devices Manufacturer
3D Imagery Service Provider
Surveillance Camera System Manufacturer
Current Weather Conditions Service Provider

The following pages should also be built at this time:
1. Property Map with Layers—These layers will include tracking devices, filters for showing and hiding contractors, user search, 3D imagery links, surveillance camera feeds, safety area/emergency mode layers, restricted area layers, and building outlines.
2. Centralized Document Control
3. Register Organizations—Will mirror the page that is in the Admin Portal
   a. External Users
   b. Device Assignment
4. Guest Setup and Device Assignment
5. Restricted Area Management
   a. Assign users
   b. Assign Organizations

Any restrictive language used in conjunction with any embodiments as disclosed herein such as “must,” “requires,” “needed,” or the like should be taken as applying only to those specific embodiments and not to embodiments as disclosed generally.

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard drive (HD)), hardware circuitry or the like, or any combination.

Embodiments of a hardware architecture for implementing certain embodiments are described herein. One embodiment can include one or more computers communicatively coupled to a network.

At least portions of the functionalities or processes described herein can be implemented in suitable computer-executable instructions. The computer-executable instructions may be stored as software code components or modules on one or more computer readable media (such as non-volatile memories, volatile memories, direct access storage drive (DASD) arrays, magnetic tapes, floppy diskettes, hard drives, optical storage devices, etc. or any other appropriate computer-readable medium or storage device). In one embodiment, the computer-executable instructions may include lines of compiled C++, Java, hypertext markup language (HTML), or any other programming or scripting code.

Additionally, the functions of the disclosed embodiments may be shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments, which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for interfacing observational tools with a 3D-modelled space comprising:
a digital location interface platform, wherein said digital location interface platform is configured to allow a user to access said digital three-dimensional (3D) representation of a location, wherein said digital location interface platform is further configured to allow said user to access data from a first observational tool.

2. The system of claim 1 wherein said user accesses said digital location interface platform via a website.

3. The system of claim 2 further comprising a first button layered on said digital 3D representation of said location wherein said first button is configured to request said data from said first observational tool.

4. The system of claim 3 wherein said first observational tool is disposed at said location and configured to observe said location to generate a substantially real-time data stream, wherein said data from said first observational tool comprises said substantially real-time data stream.

5. The system of claim 4 wherein said digital location interface platform is further configured to display said data from said first observational tool in substantially real-time.

6. The system of claim 5 wherein said first observational tool is one of a stationary closed-circuit television (CCTV) camera, a mobile camera system, a body cam, or a license plate scanner.

7. The system of claim 1 wherein said digital location interface platform is further configured to receive GPS data from a first location detection device.

8. The system of claim 7 further comprising a first location zone layered on said digital 3D representation of said location, wherein said first location zone corresponds to a set of GPS coordinates within said location.

9. The system of claim 8 wherein said digital location interface platform is further configured to send an alert when said GPS data from said first location detection device contains a GPS position that is within said first location zone.

10. The system claim 9 wherein said first location detection device is associated on said digital location interface platform with a first invitee.

11. The system of claim 10 wherein said alert is sent to an alert device associated with said first invitee.
